(19) United States
(12) Patent Application Publication
(10) Pub. No.: US 2026/0363485 A1
(43) Pub. Date: Nov. 19, 2026

(54) Heat Resistant Shelf Extension Assembly for Gas Griddle/Grill

(71) Applicant: Construction Protection System, LLC, Castle Pines, CO (US)

(72) Inventors: Michael B. Brisbois, Castle Pines, CO (US); Richard A. Brisbois, Plano, TX (US); Dawson F. Swan, Loveland, CO (US); Christopher F. Meduna, Loveland, CO (US)

(21) Appl. No.: 19/747,939

(22) Filed: Jul. 20, 2026

Related U.S. Application Data
(63) Continuation-in-part of application No. 19/407,710, filed on Dec. 3, 2025, now Pat. No. 12,733,773.
(60) Provisional application No. 63/740,507, filed on Dec. 31, 2024.

(51) Int. Cl. A47J 37/07

(52) U.S. Cl. CPC A47J 37/0786

(57) ABSTRACT

A shelf extension assembly configured to be placed over and secured to the metal shelf of a propane/gas griddle or grill is described. The shelf extension assembly comprises a clip assembly including a single-piece bracing clip frame that is attached to the metal shelf of the griddle and facilitates the attachment and removal of an extended shelf that covers and rests on the underlying metal shelf. The extended shelf is fabricated of materials that are heat resistant and have a relatively low thermo-conductivity allowing it to remain significantly cooler than the metal shelf.

### CROSS-REFERENCE TO RELATED APPLICATION

This application is a continuation-in-part of U.S. Application No. 19/407,710, filed Dec. 03, 2025. This application claims the benefit of and incorporates by reference U.S. provisional patent application 63/740,507 entitled “Heat Resistant Shelf Extender for Gas Griddle and Grill” filed on Dec. 31, 2024, and having two common inventors with the present application.

### BACKGROUND

A significant problem was outdoor gas fired griddles, such as the Blackstone™ griddle (and griddles of a similar design) 200 illustrated in FIGS. 1-2, is the thermo-energy from the griddle platen 205 is conductively and radiantly transferred to surrounding surfaces such as, but not limited to, the metal shelves 210 typically provided on the left and right sides of the griddle. As can be seen, the usable portion of the metal shelf is spaced away from the edge of the griddle body 215 forming an opening 225 between the griddle body and the inside edge of the usable portion of the shelf. This helps reduce heat being conducted from the griddle platen and the griddle body to the shelf. The edges of the opening comprise upturned flanges 230 that help hinder a user from inadvertently sliding a plate, tray or bowl up against the extremely hot body of the griddle. Nevertheless, a substantial amount of heat is transferred from the griddle platen to the body 215 of the griddle and then through the two attachment locations 220 of the metal shelf to the body.

When the griddle 200 is at cooking temperature and has fully warmed up, the temperatures of the metal shelves 210 can easily reach or even exceed 125 degrees F. This often makes using the shelf to hold food preparation items impractical, and presents the possibility that a user, who comes in contact with the shelf, could be burned. Simply put, the side metal shelves on a gas griddle are not very useful except for perhaps placing metal cookware and utensils thereon. Additionally, the metal shelves tend to be rather small providing little surface area to facilitate holding any more than a single plate, bowl or frying pan. Even if the temperature were not elevated to unacceptable levels, the shelf’s size, typically around 17” x 12”, does not permit practical use as a food preparation or food storage locations.

### BRIEF DESCRIPTION OF THE DRAWINGS

FIG. 1 is an illustration of a typical propane/gas griddle as is known in the art.

FIG. 2 is a close-up view of the griddle of FIG. 1 illustrating the griddle’s metal shelf and its connection to the body of the griddle as is known in the art.

FIG. 3 is a perspective view showing the shelf extension assembly attached to a metal shelf of a griddle according to an embodiment of the present invention.

FIG. 4 is a perspective front view of the clamp assembly according to an embodiment of the present invention.

FIG. 5 is a perspective top view of a bamboo extended shelf according to an embodiment of the present invention.

FIG. 6 is a perspective rear view of the clamp assembly according to an embodiment of the present invention.

FIG. 7 is a cross-sectional view of the clamp assembly taken along line 7-7 in FIG. 4 showing the clamp in the closed position according to an embodiment of the present invention.

FIG. 8 is a cross-sectional view of the clamp assembly taken along line 7-7 in FIG. 4 showing the clamp in the open position according to an embodiment of the present invention.

FIG. 9 is a cross-sectional view of the shelf extension assembly as installed on a griddle shelf taken along line 9-9 in FIG. 3 according to an embodiment of the present invention.

FIG. 10 is an exploded perspective view of the clamp assembly according to an embodiment of the present invention.

FIG. 11 is a perspective front view of a clamp assembly according to one embodiment of the present invention.

FIG. 12 is a perspective rear view of a clamp assembly according to one embodiment of the present invention.

FIG. 13 is a side view of a clamp assembly according to one embodiment of the present invention.

FIG. 14 is an exploded view of a clamp assembly according to one embodiment of the present invention.

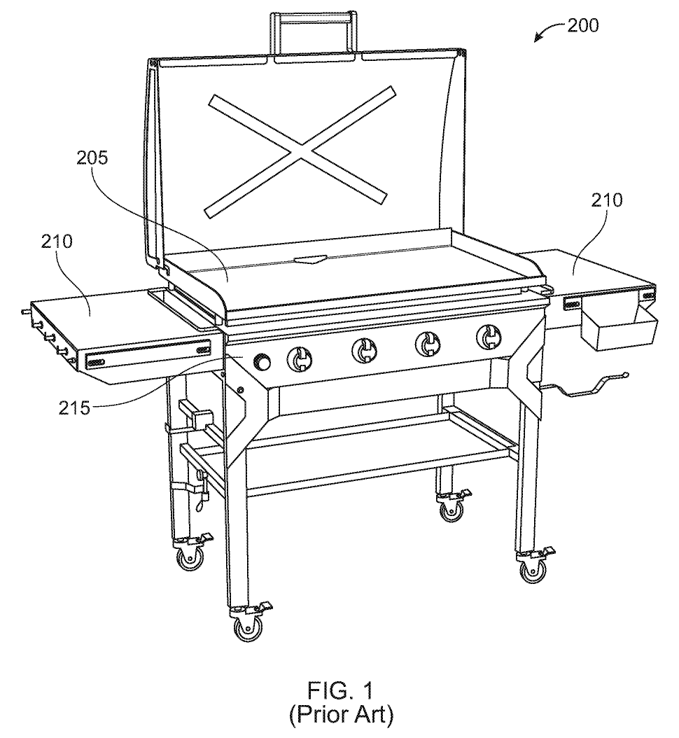

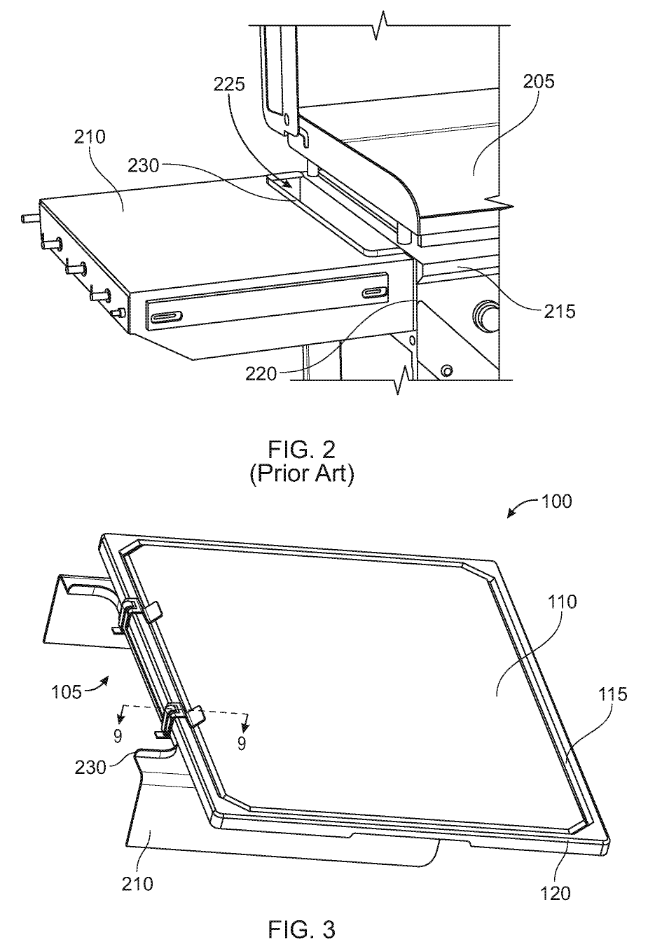

### DETAILED DESCRIPTION

Embodiments of the present invention comprise a shelf extension assembly to be placed over and secured to the underlying typically metal shelf of a propane/gas griddle or grill, such as can be found on griddles marketed and sold by Blackstone Products of Logan, UT. The shelf extension assembly described and illustrated herein comprises a clip assembly that is attached to the metal shelf of the griddle and facilitates the attachment and removal of an extended shelf that covers and rests on the underlying metal shelf. The extended shelf is configured for easy attachment and removal from the underlying metal shelf and can further serve as a tray for moving food to and from the griddle. Importantly, the shelf-extender increases the work surface when compared to the stock shelfing substantially. In one embodiment, the surface is about 100% larger. Further, the shelf is fabricated of materials that are heat resistant and have a relatively low thermo-conductivity allowing it to remain significantly cooler than the stock metal shelf. The shelf and its quick connect fastening system are stout enough to handle the weight of whatever might reasonably be placed anywhere on the extended shelf. Typically, the clip assembly components of the shelf extension assembly can be manufactured from a rigid material having a thickness of approximately 0.70mm to 1.10mm. In one example, the components can be manufactured from stainless steel and have a thickness of approximately 0.90mm.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase’s case, to the singular and plural variations of the defined word or phrase.

The term “or” as used in this specification and the appended claims is not meant to be exclusive, rather the term is inclusive meaning “either or both.”

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, upper, lower, vertical, horizontal, back, front, lateral, inwardly, outwardly, and upwardly are relative to each other and are dependent on the specific orientation of an applicable element or article, and are used accordingly to aid in the description of the various embodiments and are not necessarily intended to be construed as limiting.

Unless otherwise indicated or dictated by context, the terms “approximately” and “about” mean ±20%. Unless otherwise indicated or dictated by context, the term “substantially” means ±10%. The term “generally” means for the most part.

### A First Embodiment of a Heat-Resistant Shelf Extension Assembly

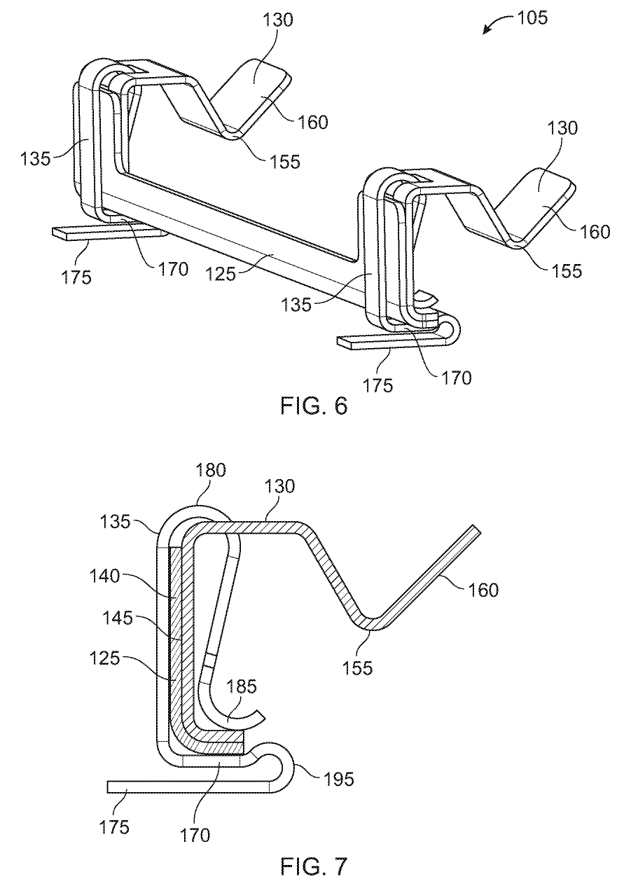

An embodiment of the shelf extension assembly 100 is described herein with reference to FIGS. 3-10. The illustrated embodiment comprises (i) an extended shelf/server platter 110 that is comprised of a material or materials that resist damage from heat and have a relatively low thermal conductivity, and (ii) a clip assembly 105 configured to permit quick removal and attachment of the extended shelf wherein the clip assembly conveniently remains in place on the metal shelf even when the extended shelf has been removed therefrom. Because the clip assembly is typically left in place, it does not have to be installed, touched or adjusted when it and/or the metal shelf 210 are hot during griddle 205 use.

An extended shelf 110 is illustrated in FIGS. 3 & 5. The extended shelf can be made of any suitable material that is both heat resistant to temperature of about 125-250 degrees F, and has a low thermal conductivity. In one embodiment an extended shelf comprised of bamboo is utilized that is about 24” long, 18” wide and 0.63” thick, although sizes can vary substantially in other embodiments. In place of bamboo, many woods and ceramics can be used. Further, some embodiments are comprised of a polymeric composite material, such as a laminated paper and phenolic resin composite made by Richlite of Tacoma, Washington. Other composites include but are not limited to epoxy reinforced with fiberglass or carbon fiber.

As shown, the top surface of the extended shelf 110 is characterized by a trough 115 that extends around the surface proximate the edges and perimeter thereof. The trough can receive the tips of the V-shaped portion of generally V-shaped arms 155 of the bracing clips 130 therein to more firmly secure the extended shelf to the underlying metal shelf 210. As can be seen in FIG. 9, the cross section of the trough can be generally V-shaped to correspond with the rear surfaces of the V-shaped arm to make removal of the extended shelf from the clip smoother and easier. Additionally, the perimeter edges 120 of the top surface of the extended shelf are beveled. The surface of the beveled edge interfaces with the forward surface of the V-shaped arm to make insertion of the extended shelf into the clip smoother and easier. In some instances, a perimeter edge of a bottom surface of the extended shelf can be beveled.

When removed from the griddle, the extended shelf 110 can be used as a serving platter and/or food prep station. In some variations of the shelf, handle cutouts or handle recesses 123 can be provided to make carrying the extended shelf to and from the griddle. In the illustrated variation, through holes 127 are provided proximate each of the corners. These holes are configured to receive corresponding tabs of silicone corner covers 133. The silicone covers are shown on two of the corners but in use all four corners would typically be covered. The covers provide a non-slip surface to help hold the shelf in place on another flat service, such as a table or countertop when being used as a serving tray or food prep surface.

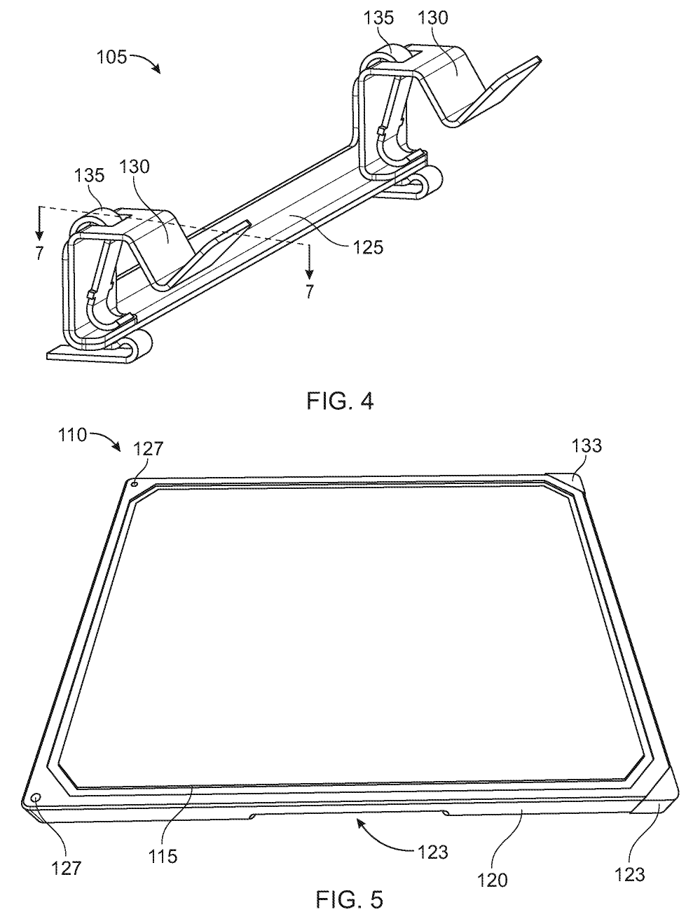

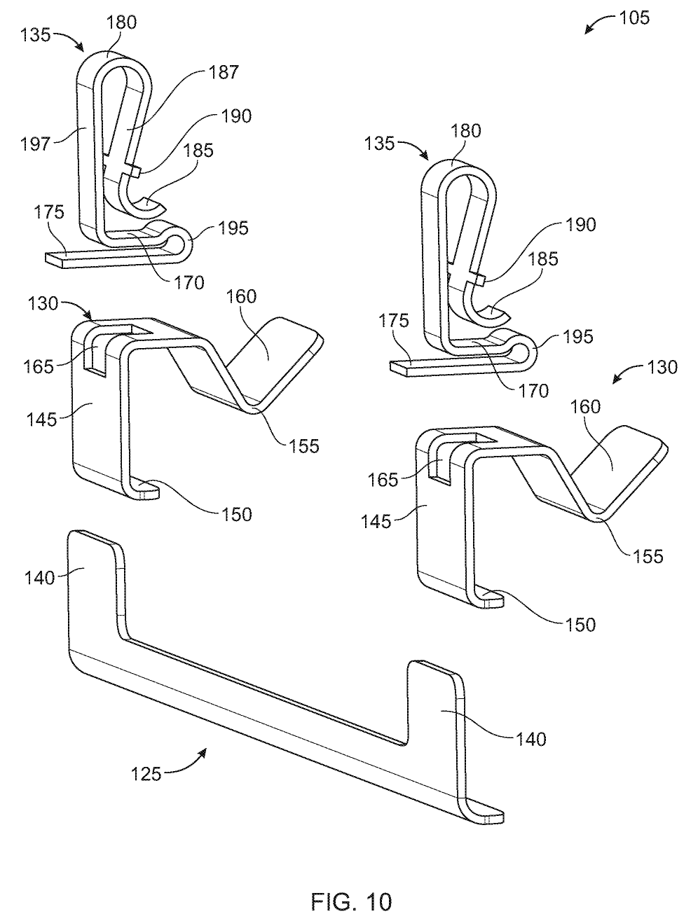

An assembled clip assembly 105 is illustrated in FIGS. 4 & 6-8, and an exploded view of the clip assembly is provided in FIG. 10. The clip assembly substantially comprises five components: one connector frame 125; two bracing clips 130; and two spring clips 135. The various pieces in one embodiment are comprised of stamped and formed sheet steel although variations made of other suitable materials are contemplated including versions made from heat resistant reinforced plastics.

The connector frame 125 acts to connect the two bracing clips 130 with one at either end of the connector frame. The vertical legs 145 of the bracing clips are attached to ends of the frame by any suitable means including adhesive joining, welding, and/or mechanical attachment. It is appreciated that variations of the clip assembly 105 are contemplated that comprise two separate clips without a connector frame; However, by joining two (or more) clips the use of the shelf extension assembly is improved as is adequate and desirable spacing of the clips along the metal shelf maintained for a more secure connection of the extended shelf.

The bracing clips 130 act to securely hold the extended shelf 110 in place against the underlying metal shelf 210 with the extended shelf’s edge most proximate the griddle body 220 positioned close to the upwardly-turned flange 230 of the metal shelf. The bracing clips are typically generally C-shaped. At a bottom end, the clip comprises a bottom foot 150 that braces against the bottom surface of the metal shelf 210 proximate the upwardly extending flange as can be seen in FIG. 9. The top portion of the clip comprises a resilient V-shaped arm 155 configured to interface with the trough 115 of the extended shelf 110. The arm further includes an extended tab 160 that permits a user to flex the arm upwardly as necessary when inserting or removing the extended shelf from the clip assembly. The bottom foot and arm are coupled by way of the intervening generally vertical leg 145. It is typically along the surface of the leg that the bracing clip is secured to the connector frame. Further, a generally rectangular slot 165 extends through the clip spanning the intersection of the vertical leg and the V-shaped arm. The slot permits a portion of the spring clip 135 to pass therethrough.

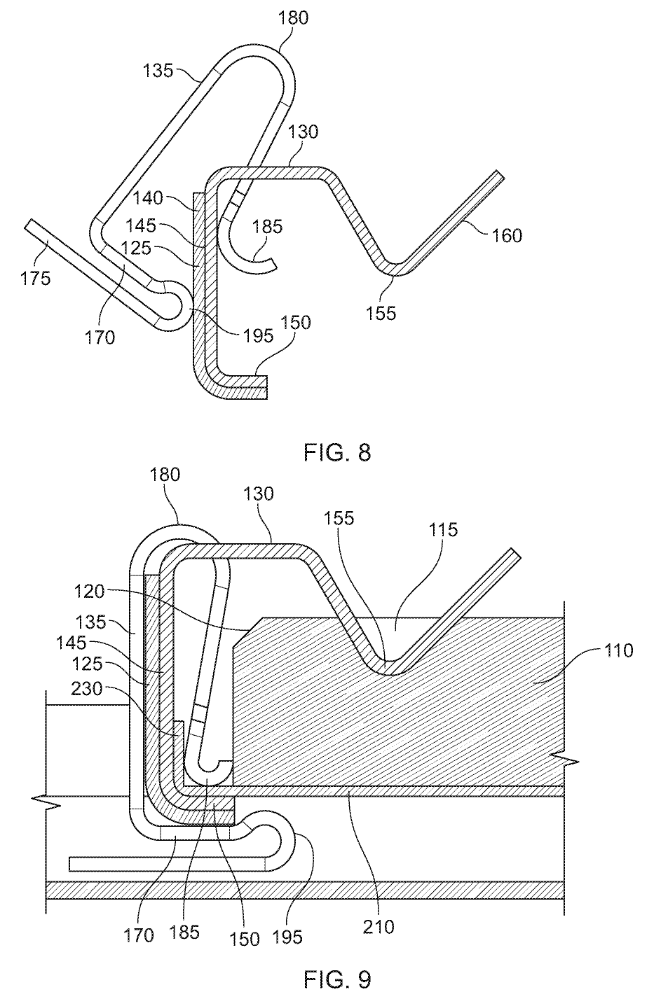

The spring clips 135 act to hold the bracing clips 125 and the entire clip assembly 105 in place on the metal shelf 210 generally up against the upwardly extending flange 230 that borders the opening 225 between the body 215 of the griddle and the metal shelf. Effectively, the spring clip, when deployed, holds the clip assembly to the metal shelf while the extended shelf is being inserted or removed therefrom. FIGS. 4, 6, 7 & 9 show the spring clips in the deployed position; whereas FIG. 8 shows a spring clip in the undeployed position as would be used when installing or removing the clip assembly from the metal shelf as is described later.

The resilient spring clip 135 includes a spring clip tab 175 at the bottom end that a user can press a finger against either to install the clip assembly 105 on a metal shelf 210 or remove the clip assembly from the metal shelf. The tab is connected to the spring clip bottom foot 170 by way of a curved bend 195. The foot braces against the bottom of the connector frame 125 to help hold the clip assembly 105 securely against the bottom of the metal shelf. A spring clip leg 197 extends vertically from an intersection with the spring clip bottom foot interfacing with an upper curved bend 180 having a circumferential extent of about 210 degrees. The upper curved bend transitions into a downwardly and inwardly extending spring clip arm 187. The arm in turn transitions into an arcuate spring clip hand 185. As can best be seen in FIG. 9, when the spring clamp is deployed, the spring clamp hand presses both down against the horizontal top surface of the metal shelf and laterally against the upwardly-extending flange 230 forcing it against the vertical leg 145 of the bracing clip 130 thereby fixing the clip assembly in place on the metal shelf. The spring arm clip also includes an opposing pair of spring clip retaining tabs 190 that extend generally horizontally outwardly from the left and right edges thereof. The distance between the end of the left tab and the end of the right tab is greater than the width of the generally rectangular slot 165 of the bracing clip. The purpose of the retaining tabs being to prevent the spring clips 135 from separating from the rest of the clip assembly when the assembly is not installed.

### A Second Embodiment of a Heat-Resistant Shelf Extension Assembly

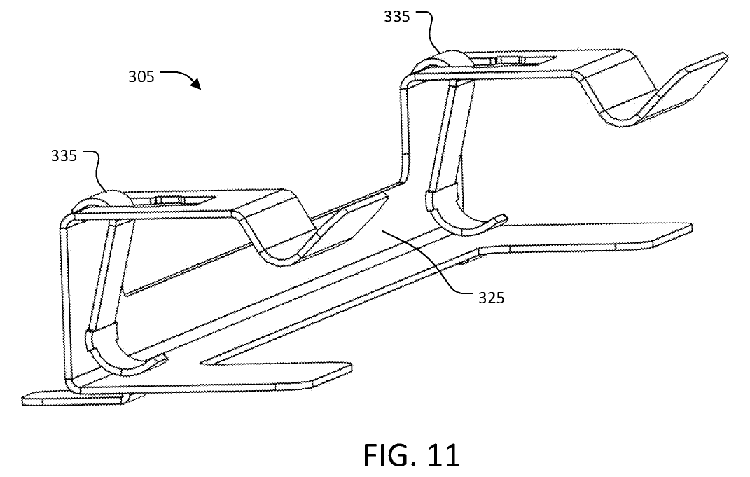

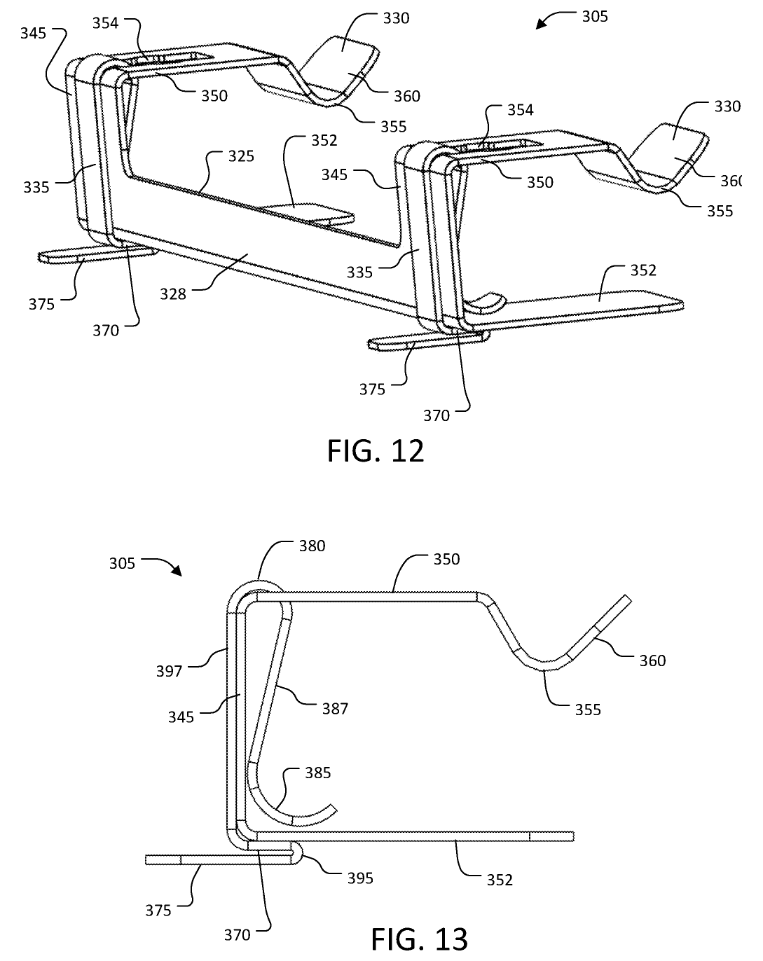

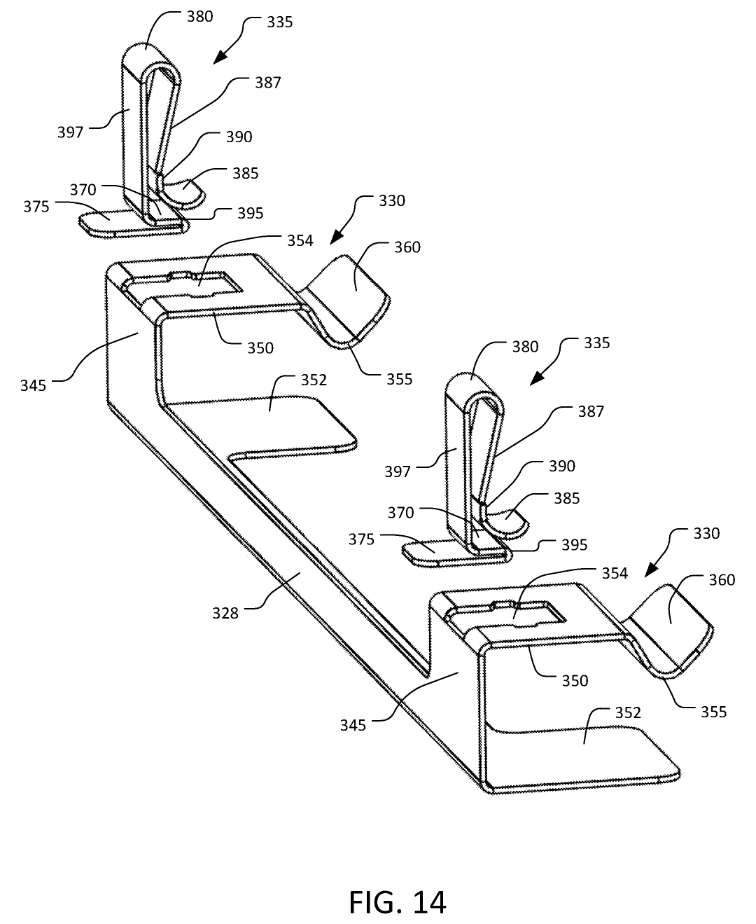

A second embodiment assembled clip assembly 305 is illustrated in FIGS. 11-13, and an exploded view of the clip assembly 305 is provided in FIG. 14. The clip assembly 305 can include, but is not limited to, three components: a bracing clip frame 325 and two spring clips 335. The various pieces in one embodiment are comprised of stamped and formed sheet steel although variations made of other suitable materials are contemplated including versions made from heat resistant reinforced plastics.

The bracing clip frame 325 can be defined by, but is not limited to, a middle horizontal extension 328 and opposing ends being configured as bracing clips 330. The bracing clips 330 can each include a vertical leg 345, an upper horizontal flange 350, a lower horizontal flange 352, a slot 354, a resilient V-shaped arm 355, and an extended tab 360. The vertical leg 345 can extend up from a lower section of the bracing clip frame 325 with the upper horizontal flange 350 extending from a top of the vertical leg 345 and the lower horizontal flange 352 extending from a bottom of the vertical leg 345. Although the lower horizontal flange 352 is shown with center portion being shorter in width than proximate the bracing clips 330 portion, instances are contemplated where the lower horizontal flange 352 is the same width for an entire length of the bracing clip frame 325. The upper horizontal flange 350 can include the slot 354 for receiving a portion of the spring clip 335 therethrough. The resilient V-shaped arm 355 can extend from a distal end of the upper horizontal flange 350 and can include the extended tab 360. The bracing clip frame 325 can act to securely hold the extended shelf 110 in place against the underlying metal shelf 210 with the extended shelf’s edge most proximate the griddle body 220 positioned close to the upwardly-turned flange 230 of the metal shelf.

As shown in FIG. 13, the bracing clips 330 are typically generally C-shaped. The lower horizontal flange 352 can brace against a bottom surface of the metal shelf 210 proximate the upwardly extending flange 230, similar to the clamp assembly 105 as can be seen in FIG. 9. The upper horizontal flange 350 of the bracing clip 330 can include the resilient V-shaped arm 355 configured to interface with the trough 115 of the extended shelf 110. The V-shaped arm 355 can further include the extended tab 160 that permits a user to flex the V-shaped arm 355 upwardly as necessary when inserting or removing the extended shelf from the clip assembly 305. The slot 354 can permit a portion of the spring clip 335 to pass therethrough.

The spring clips 335 act to hold the clip assembly 305 in place on the metal shelf 210 generally up against the upwardly extending flange 230 that borders the opening 225 between the body 215 of the griddle and the metal shelf. Effectively, the spring clip 335, when deployed, holds the clip assembly 305 to the metal shelf while the extended shelf is being inserted or removed therefrom.

The resilient spring clip 335 can include a spring clip tab 375 at the bottom end that a user can press a finger against either to install the clip assembly 305 on a metal shelf 210 or remove the clip assembly 305 from the metal shelf. The tab 375 can be connected to a spring clip bottom foot 370 by way of a curved bend 395. The foot 370 can brace against the bottom of the bracing clip frame 325 (e.g., the lower horizontal flange 352) to help hold the clip assembly 305 securely against the bottom of the metal shelf. A spring clip leg 397 extends vertically from an intersection with the spring clip bottom foot 370 interfacing with an upper curved bend 380 having a circumferential extent of about 210 degrees. The upper curved bend 380 transitions into a downwardly and inwardly extending spring clip arm 387. The inwardly extending spring clip arm 387 in turn transitions into an arcuate spring clip hand 385. Similar to the clamp assembly 105 as can best be seen in FIG. 9, when the spring clamp 335 is deployed, the spring clamp hand 385 can be configured to press both down against the horizontal top surface of the metal shelf and laterally against the upwardly-extending flange 230 forcing it against the vertical leg 345 of the bracing clip 330 thereby fixing the clip assembly 305 in place on the metal shelf. The spring clip arm 387 can also include an opposing pair of spring clip retaining tabs 390 that extend generally horizontally outwardly from the left and right edges thereof. The distance between the end of the left tab and the end of the right tab can be greater than the width of the slot 354 of the bracing clip 330. The purpose of the retaining tabs being to prevent the spring clips 135 from separating from the rest of the clip assembly when the assembly is not installed.

### A Method of Installing and Using of an Embodiment of the Heat-Resistant Shelf Extension Assembly on a Griddle’s Metal Shelf

Described hereinafter is one example method for installing the shelf extension assembly 100. It is to be appreciated that the same general method can be used to install the second embodiment clip assembly 305 with the previously described components of the shelf extension assembly 100 without undue burden. To install the shelf extension assembly 100, the user first attaches the clip assembly 105 (or clip assembly 305) to the metal shelf 210. This comprises positioning the clip assembly against the long-flanged edge of the metal shelf’s opening 225 with the spring clips in the undeployed position as shown in FIG. 8. The foot 150 of each bracing clip 130 is placed underneath the metal shelf and in contact with its bottom surface. Next, the user presses each spring clip 135 downwardly at their respective upper curved bend 180. This causes the spring clip hand 185 to slide over and in front of the flange 230 effectively securing the clip assembly in place. The curve of the spring clip hand 185 acts to guide it over the upwardly-extending flange.

Next, to install the extended shelf 110, the user rests the extended shelf on the surface of the metal shelf 210 with the extended shelf’s desired edge in front of and parallel to the clip assembly 105. The user then pushes the shelf into the bracing clips until the V-shaped arms 155 are received in the trough 115 of the extended shelf to secure it in place.

The extended shelf 110 is then used in any manner desired by the user including, but not limited to, a food staging area for holding meat or other uncooked food prior to it being placed on the griddle, a receiving area for cooked food, a food preparation station, and a holding area for pans and cooking utensils. Although the extended shelf assembly 100 has been described singularly, it is to be appreciated that since many gas griddles and grills have two metal shelves, and accordingly, two extended shelf assemblies can be fitted to a grill, such that, for instance, one side can be used to hold uncooked food and the other side could be used to receive and hold cooked food.

As desired the user can remove the extended shelf 110 easily from the clip assembly 105, which typically remains attached to the metal shelf 210. The shelf can be removed by gently pulling it away from the clip assembly to be used as a serving tray and/or for cleaning. It is appreciated that the extended shelf, which in some embodiment including the bamboo embodiment described herein, can be used: (i) as a food-grade surface for the preparation of food to be cooked at a location remote from the grilled; (ii) to carry the pre-cooked prepared food to the grill whereat the shelf is secured in place on top of the smaller metal shelf; (iii) to receive cooked food; and (iv) to act as a serving tray for the cooked food. When not in use the extended shelf can be stored upright in a pantry, closet or cupboard until needed.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A shelf extension assembly for a gas grill or griddle having at least one metal shelf independently coupled to the gas grill or griddle, the shelf extension assembly comprising:
a non-metal extended shelf; and
a clip assembly adapted to (i) fixedly and removably couple to the at least one metal shelf, and (ii) removably secure the extended shelf to the at least one metal shelf, the clip assembly comprising:
a single-piece bracing clip frame having opposing ends each forming a bracing clip; and
two spring clips, each of the two spring clips operatively coupled to one of the bracing clips;
wherein (i) each of the bracing clips includes an opening therethrough through which a corresponding spring clip is received; and (ii) the bracing clips are configured to hold the extended shelf to the clip assembly and one of the at least one metal shelf.

2. The shelf extension assembly of claim 1, wherein each of the bracing clips is defined by a substantially “C” shape formed from a lower horizontal flange, a vertical leg, and an upper horizontal flange.

3. The shelf extension assembly of claim 2, wherein the upper horizontal flange includes a slot used as the opening for receiving a portion of the spring clip therethrough.

4. The shelf extension assembly of claim 2, wherein the upper horizontal flange includes a V-shaped arm and an extended tab.

5. The shelf extension assembly of claim 4, wherein the extended shelf is rectangular and includes four edges with a trough extending around a perimeter of a top surface proximate the edges.

6. The shelf extension assembly of claim 5, wherein a tip of a V-shaped portion of the V-shaped arm is adapted for receipt into the trough extending around the top surface near the perimeter thereof.

7. A combination comprising the shelf extension assembly of claim 1, and the gas grill or griddle.

8. The combination of claim 7, wherein the area of the extended shelf is at least 50% greater than the area of the at least one metal shelf.

9. The shelf extension assembly of claim 1, wherein the extended shelf comprises one of wood, ceramic, porcelain, a reinforced polymer, a polymer-based composite, and bamboo.

10. The shelf extension assembly of claim 1, wherein the extended shelf is bamboo.

11. The shelf extension assembly of claim 1, wherein the clip assembly is comprised substantially of sheet steel.

12. The shelf extension assembly of claim 11, wherein the sheet steel has a thickness of approximately 0.70mm to 1.10mm.

13. The shelf extension assembly of claim 11, wherein the sheet steel is stainless steel and has a thickness of approximately 0.90mm.

14. The shelf extension assembly of claim 1, wherein the clip assembly is manufactured from substantially stainless steel and has a thickness of approximately 0.90mm.

15. A shelf extension assembly for a gas grill or griddle having at least one metal shelf independently coupled to the gas grill or griddle, the shelf extension assembly comprising:
a non-metal extended shelf; and
a clip assembly adapted to (i) fixedly and removably couple to the at least one metal shelf, and (ii) removably secure the extended shelf to the at least one metal shelf, the clip assembly consisting essentially of:
a single-piece bracing clip frame having opposing ends each forming a bracing clip; and
two spring clips, each of the two spring clips operatively coupled to one of the bracing clips;
wherein (i) each of the bracing clips includes an opening therethrough through which a corresponding spring clip is received; (ii) the bracing clips are configured to hold the extended shelf to the clip assembly and one of the at least one metal shelf; and (iii) the clip assembly being manufactured from substantially stainless steel and has a thickness of approximately 0.90mm.

16. A combination comprising the shelf extension assembly of claim 15, and the gas grill or griddle.

17. The combination of claim 16, wherein the area of the extended shelf is at least 50% greater than the area of the at least one metal shelf.

18. The shelf extension assembly of claim 15, wherein the extended shelf comprises one of wood, ceramic, porcelain, a reinforced polymer, a polymer-based composite, and bamboo.

19. The shelf extension assembly of claim 15, wherein the extended shelf is bamboo.

20. A shelf extension assembly for a gas grill or griddle having at least one metal shelf independently coupled to the gas grill or griddle, the shelf extension assembly comprising:
a non-metal extended shelf; and
a clip assembly adapted to (i) fixedly and removably couple to the at least one metal shelf, (ii) removably secure the extended shelf to the at least one metal shelf, (iii) be manufactured from substantially stainless steel and have a thickness of approximately 0.90mm, the clip assembly comprising only 3 components:
a single-piece bracing clip frame having opposing ends each forming a bracing clip; and
two spring clips, each of the two spring clips operatively coupled to one of the bracing clips;
wherein (i) each of the bracing clips includes an opening therethrough through which a corresponding spring clip is received; (ii) the bracing clips are configured to hold the extended shelf to the clip assembly and one of the at least one metal shelf.
